(19) United States
(12) Patent Application Publication
(10) Pub. No.: US 2006/0185232 A1
(43) Pub. Date: Aug. 24, 2006

(54) Tree anchor apparatus and method

(76) Inventor: David A. Spicer, Whitefield, ME (US)

Correspondence Address: CHRIS A. CASEIRO, VERRILL DANA, LLP, ONE PORTLAND SQUARE, PORTLAND, ME, 04112-0586, US

(21) Appl. No.: 11/062,651

(22) Filed: Feb. 22, 2005

(51) Int. Cl. A01G 17/10

(52) U.S. Cl. 47/42

(57) ABSTRACT

An improved tree stabilization system with a perimeter anchor system of a plurality of individual ground anchor assemblies configured adjacent to the tree or shrub to be supported and a related stabilization method. The tree stabilization system is particularly well suited for use in securing mature trees and stands of trees. As it is adjustable, it may be used for long term stability rather than simply during initial root development. The tree stabilization system includes a retention system that is attached to the perimeter anchor system and runs over the root system and pins the root system to the ground at certain important locations. The ground anchor assemblies are inserted into the ground so that the top end to which the retention system is attached is at or under ground level. The tree stabilization system may include a configuration for anchoring an entire stand of trees and may include a feature for adjusting the tension of the retention system to allow the appropriate amount of downward pressure as conditions change.

### BACKGROUND OF THE INVENTION

1. Field of the Invention

The present invention relates to stabilizing trees and shrubs. More particularly, the present invention relates to an apparatus and method for anchoring the root systems of trees and shrubs to the ground to assist them in remaining upright. Still more particularly, the present invention relates to a system of retention structures above the root system at or just below ground level to retain the root systems.

2. Description of the Prior Art

It is common for trees to encounter stability problems due to a variety of conditions. For the purposes of the description of the present invention, the word tree includes trees, woody shrubs, and plants. Even the healthiest of trees can tilt or fall over completely due to conditions such as excess moisture in the ground, high winds, the unexpected application of force by an object such as a collision by a car or another tree falling. In such situations, it is often the lack of adequate support from the root system that leads to a tree uprooting and tilting or falling.

The situations in which the need to stabilize trees arises may be endless. For instance, mature trees located close to houses or other valuable property could be stabilized to prevent the trees from falling and causing significant property damage. Perhaps an especially desirable tree should be preserved. Trees may be located to shelter a structure such as a house from extreme weather conditions such as high prevailing winds, in which case, such sheltering trees could be stabilized in a way that maximizes their resistance to such winds.

Conventional devices focus on stabilizing newly planted trees and shrubs, and generally consist of two or more stakes driven into the ground adjacent to the trunk of the tree or shrub. The stakes are attached to wires or cables that connect the stakes to the trunk. The connection to the trunk consists of wrapping the wire around the circumference of the trunk and inserting padding to protect the trunk. The trunk receives support from the wires because the lateral movement of the trunk is inhibited.

There are several limitations associated with such conventional devices. One limitation is that the devices support the trunk, but not the root system. It is, however, the root system that most often is the weakest link. Some studies indicate that trees and shrubs fall more often because of failure of a significant root. Another limitation is that the stakes and wires are located above ground level. They are therefore unsightly and can detract from the appearance of the tree or shrub. They are also dangerous to pedestrians, children, landscaping equipment and other activities. The exposure increases susceptibility to intentional or accidental damage. For instance, stakes may become loose from regular bumping by a lawnmower or trimmer. The wire connection can also damage the tree trunk. Friction can wear away bark and/or the trunk can grow big enough to become constricted by the wire. A further undesired limitation is that such devices cannot support large trees and are not permanent in nature.

U.S. Pat. No. 6,625,926, Mancini, titled Tree and Shrub Stabilizing Apparatus and Method for Stabilizing a Tree or Shrub, shows an apparatus and method for stabilizing newly planted trees and shrubs. Mancini shows a plurality of stakes attached to a plurality of straps. The stakes are driven into the ground in an arrangement around the hole into which a tree is being planted. The straps contact the root ball and provide support with downward pressure. The invention is designed to provide temporary support to newly planted trees and, in the preferred embodiment, teaches the use of biodegradable straps. This invention, however, does not address the problem of permanently securing trees or securing mature trees that have been planted for some time. The invention thus lacks a means for permanently securing a tree that has a mature root system rather than a root ball. It also lacks a means of adjusting the tension of the straps after installation. Such adjustment capability is critical for long term stabilization because conditions change over time and varying amounts of pressure are needed. Changing conditions include soil erosion, changes in moisture levels, wind loading due to neighboring trees being removed or blown down, and root system growth and shifting. The Mancini device also cannot be used to secure an entire stand of trees.

Therefore, what is needed is a system for permanently stabilizing both large and small trees by anchoring the root system to the ground. The system must be adaptable for use with a variety of root systems and landscaping conditions ranging from loose, sandy soil to solid rock. The system must be capable of being installed at or just below the surface of the ground. The means for supporting the root system should be adjustable to allow appropriate pressure as required by changing conditions. The system must be capable of being positioned around a single tree or a stand of trees to stabilize the entire stand.

### SUMMARY OF THE INVENTION

It is an object of the present invention to provide artificial support for the root systems of trees or shrubs. It is also an object of the present invention to provide such support with an anchor perimeter fixed in the ground. The ground may consist of soil or rock or both. The anchor perimeter includes a plurality of individual ground anchors attached to a retaining system running above the root system but at or just below the ground surfaces. It is also an object of the invention to provide a means for adjusting the tension of the retaining system to ensure the proper amount of support is provided to the root system as conditions change. It is also an object of the invention to provide support to stands of trees and shrubs.

These and other objects are achieved by the present invention, which is a tree stabilization system and related method. The stabilization system includes a perimeter anchor system and a retention system. The perimeter anchor system is affixable in the underlying soil or rock. The perimeter anchor system includes a plurality of ground anchor assemblies, each terminated at the top thereof by a fixing component positioned at or below the surface of the ground. One or more retention means such as a retaining cable or cables is/are attached to the ground anchor assemblies at the fixing component, preferably but not necessarily, with adjustment means to tighten the retention means when desired. The retaining cables may be detachably connected to the fixing component such as by a bolt or other such detachable connecting means. An eyebolt or other looped structure may also be affixed to the fixing component to optionally retain a means for connecting the ground anchor assemblies to the trunk such as a guy wire. A load distribution means to distribute the downward pressure laterally from the cable across a wider lateral area to the root system, and to minimize root damage over time, may be included. The stabilization system can be positioned around a single tree or a stand of trees to stabilize the entire stand.

The present invention is a stabilization system suitable for retaining the roots of trees in place under sporadic high load conditions, such as severe wind gusts. The stabilization system is positioned about the tree or set of trees, preferably just at or below the ground surface. That positioning ensures that the most significant roots of the tree are retained by the retention system without impeding traffic about the tree or trees. The adjustability of the retention system ensures that the stabilizing load may be maintained at a constant over a long period of time with minimal root damage. These and other advantages of the invention will become apparent upon review of the following detailed description, the accompanying drawings and the appended claims.

### BRIEF DESCRIPTION OF THE DRAWINGS

FIG. 1 is a side view of the stabilization system positioned about a single tree.

FIG. 2 is an overhead view of the stabilization system as shown in FIG. 1.

FIG. 3, comprising FIGS. 3A-3D, provides side views of four different embodiments of the ground anchor assembly of the perimeter anchor system of the present invention.

FIG. 4, comprising FIGS. 4A-4C, provides side views of three versions of the first embodiment of the ground anchor assembly of FIG. 3A.

FIG. 5 is a detailed side view of the fourth embodiment of the ground anchor assembly of FIG. 3D.

FIG. 6 is a detailed side view of an embodiment of the perimeter anchor system and the retention system of the present invention.

FIG. 7 is a side view of an adjustable retainer of the retention system.

FIG. 8. is a side view of a first embodiment of the adjustable retainer.

FIG. 9 is a side view of a second embodiment of the adjustable retainer.

FIG. 10 is atop view of a first embodiment of the stabilization system to stabilize a stand of trees.

FIG. 11 is a top view of a second embodiment of the stabilization system to stabilize a stand of trees.

FIG. 12 is a top view of a third embodiment of the stabilization system to stabilize a stand of trees.

FIG. 13 is a top view of a fourth embodiment of the stabilization system with an alternative arrangement for a stand of trees.

FIG. 14 is a top view of an optional retention load distribution device of the present invention.

### DETAILED DESCRIPTION OF THE PREFERRED EMBODIMENT

As illustrated in FIGS. 1 and 2, the present invention is a tree stabilization system 10 position about a tree 100 to be stabilized. The stabilization system 10 includes a perimeter anchor system 12 and a retention system 14. The perimeter anchor system 12 is installed in the ground around the tree 100 proximate to the tree trunk 110 at or just below the ground surface 120. The retention system 14 is removably affixed to the perimeter anchor system 12 about the roots of the tree 100 and in contact with those roots through application of downward pressure developed by the perimeter anchor system 12. The perimeter anchor system 12 includes a plurality of ground anchor assemblies 16, arranged in a configuration most advantageous for given conditions of the underlying ground and the area around the tree 100. FIG. 1 shows a configuration of four ground anchor assemblies 16 arranged in a square around a single tree, but other configurations are possible. The ground anchor assemblies 16 are suitable for installation in a variety of ground conditions ranging from solid rock to loose soil. Each of the ground anchor assemblies 16 includes a top end 18 and a bottom end 20, and is designed to be installed so that their uppermost portions are at or just below ground level 120. The top ends 18 of the ground anchor assemblies 16 include a means for attaching and fixing in position the retention system 14 to the perimeter anchor system 12.

As illustrated in FIGS. 3-7, the ground anchor assemblies 16 each includes an anchor body 22, a top end 24 to which the retention system 14 is attached, and a bottom end 26 that is configured and arranged to ensure that the ground anchor assembly 16 remains affixed in the underlying substrate, whether that substrate is loose soil, clay, ledge, bedrock, or coral rock. The top end 24 includes a top plate assembly 28 for removably fixing the retention system 14 in place about the tree roots. The top plate assembly 28 preferably includes top plate 30 and a base plate 32. The top plate assembly 28 includes means for retaining the retention system 14 thereto. The retention system 14 is preferably a set of one or more cables 34 attached to the ground anchor assemblies 16 at the top plate assembly 28. The retention system 14 is attached to the ground anchor assemblies 16 in a manner that allows the retention system 14 to run above important parts of the root system, at or just below ground level 120. The cables 32 can be made of steel, stainless steel, Kevlar™, or any other material suitable for attaching to the ground anchor assemblies 16 and of sufficient strength to maintain the roots in place under varying loads. The retention system 14 is installed with tension necessary to provide the proper amount of support for the root system.

The ground anchor assemblies 16, including the body 22, the top end 24, and the bottom end 26, are preferably made from steel, but any relatively strong rigid material is acceptable. The bottom end 26 is configured and designed to ensure that it may be inserted into the ground and affixed in place once there. A standard stake would not be sufficient for the purpose of the present invention as such a component would likely loosen over time and cause slack in the stabilization system 10 that could not be taken up without considerable adjustment thereof. Such a requirement would not be conducive to an effective stabilization of a tree or set of trees over a period of years. Nevertheless, the bottom end 26 may be tapered, pointed, or threaded. It may also have a cutting end for boring into the ground. Alternatively, the bottom end can be a straight pipe or bar with or without threads. However, it also includes means for securing in the ground. A hole may be predrilled in the ground to facilitate installation of the ground anchor assembly 16.

In a first embodiment of the ground anchor assembly 16 shown in FIG. 3A, a first bottom end 36 includes a threaded anchor pin. The threaded anchor pin 36 can be installed into the ground with or without a predrilled hole by rotating the anchor pin 36 in the direction (usually clockwise) causing the threads to draw the pin 36 downward. The top end 24 includes a sliding cap that causes the pin body 22 to move upwardly when the cap is moved upwardly. The top plate assembly 28 is connected to the anchor pin 36 by way of the anchor body 22 using conventional attachment means, such as threading, bolting, or pinning together. In a second embodiment of the ground anchor assembly 16 shown in FIG. 3B, a second bottom end 38 includes an expandable retention assembly 40 attached to the anchor body 22. The expandable retention assembly 40 includes one or more retention structures rotatably attached to the anchor body 22 so that as the ground anchor assembly 16 is positioned in the ground and preferably in soft soil, the retention structures of the assembly 40 dig into the ground and become affixed in place. The expansion of the retention structures, when in position, increase resistance to upward movement of the ground anchor assembly 16.

With reference to FIG. 3C, a third embodiment of the ground anchor assembly 16 is shown. The third embodiment includes a third bottom end 42 formed as a bit to facilitate installation of the ground anchor assembly 16 into the ground. The bit can be any type that is suitable for boring into soil or rock. The top plate assembly 28 of this embodiment is optionally removable to allow easier attachment and maintenance of the retention system 14. Any of the many known means for detachably attaching are acceptable, including threads, bolts, or pins.

FIGS. 3D and 5 show a fourth embodiment of the ground anchor assembly 16 with a fourth bottom end 44 and including one or more cartridges 46 or some other means for retaining therein a liquid phase material 48 with the ability to harden, such as resin or concrete. Alternatively, the liquefied material 48 may be displaced through the end of the body 22, which in that instance would be a hollowed body, using pump or injection means applied to the top of the body 22 without an internal cartridge. After first inserting the ground anchor assembly 16 into a hole, an injection means 50 is activated to inject the liquid phase material 48 into the surrounding soil through one or more openings 52 in the bottom end 44, which injected liquid phase material 48 hardens to form a more secure anchoring platform 54. In one example, a plunger 50 is placed in the hollow portion of the bottom end 44 of the ground anchor assembly 16 as the means to force the liquid phase material 44 through the openings 52. In operation, the bottom end 44 is installed in the ground and the plunger 50 is pushed downward to compress the cartridge 46 containing the liquid phase material 48. The resulting pressure forces the liquid phase material 48 out of the opening(s) 52 in the bottom end 44 of the ground anchor assembly 16 and into the surrounding soil where the liquid phase material 44 hardens.

In the arrangement of the ground anchor assembly of FIG. 5, the top plate assembly 28 may include a cover plate 54 with a bolt 56, which is screwed into the top plate 30 and retains the retention system 14 therein. The cartridges 46 may be stackable or all a single assembly and of variable volume for use dependent upon the ground within which the ground assembly 16 is retained. For example, more material 48 is required for sandy soils. The cartridges 46 preferably include a gasket 58 to prevent the material 48 from passing into the interior of the hollow anchor body 22. Further, the openings 52 may be smooth, rough for better adhesion, or even include retention structures such as those shown in FIG. 3B. It is to be noted that for this arrangement, it may be necessary to use a drive rod (not shown) to force the ground anchor assembly 16 into the ground and to force the material 48 through the openings 52. A hydraulic hammer may also be used for either purpose.

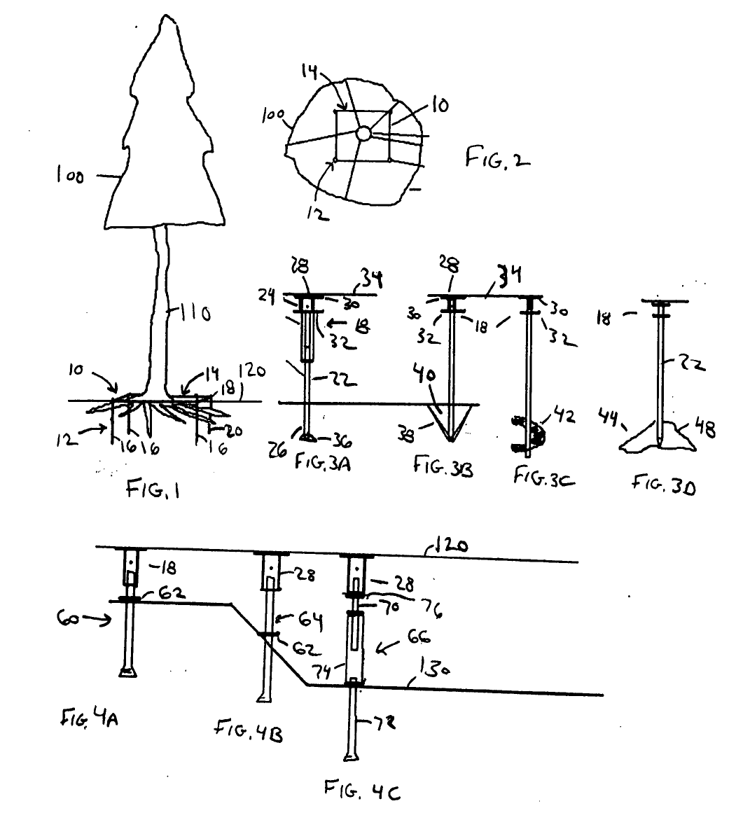

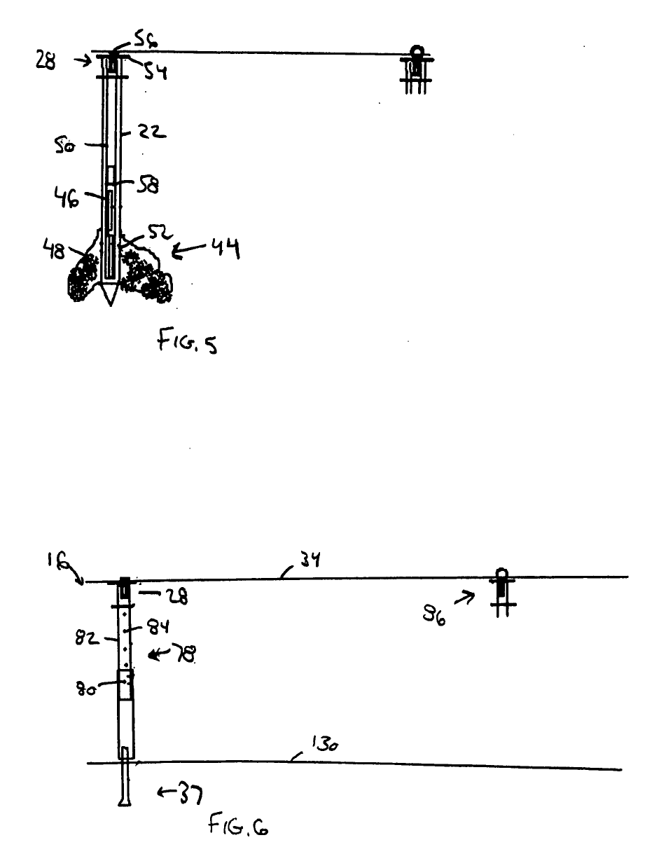

FIGS. 4A-4C show variants of the first ground anchor assembly of FIG. 3A particularly suited for installation in rock. As shown in FIG. 4A, with a short distance between the ground level 120 and the underlying bedrock 130, a short anchor body 60 or short ledge pin may be joined to the top plate assembly 28 that is hollow or solid, with a bedrock plate 62 affixed at a point on the short anchor body 60 at the surface of the bedrock 130. The short anchor body 60 may be hammered or screwed into rock. As shown in FIG. 4B, with an intermediate distance between the ground level 120 and the underlying bedrock 130, a small anchor body 64 or small ledge pin may be joined to the top plate assembly 28 that is hollow or solid, with the bedrock plate 62 affixed at a point on the small anchor body 64 at the surface of the bedrock 130. The small anchor body 64 may be threaded and may be hammered or screwed into rock. As shown in FIG. 4C, with a long distance between the ground level 120 and the underlying bedrock 130, a long anchor body assembly 66 includes an intermediate anchor rod 70 and a bottom anchor rod 72 adjustably joined together with a coupling tube 74 that allows for modification of the complete length of the long anchor body assembly 66. The intermediate anchor rod 70 may be joined to the top plate assembly 28 that is hollow or solid. The bedrock plate 62 is affixed at a point on the coupling tube 74 at the surface of the bedrock 130. The anchor rods 70 and 72 may be male threaded and the coupling tube 74 female threaded. Washers or flare heads 76 ensure that the top plate assembly 28, and anchor rods 70 and 72 remain set in the desired positions. The assembly of FIG. 4C allows for substantial adjustment of the length of the ground anchor assembly 16. Specifically, rotation of the top plate assembly 28 draws the bottom anchor rod upward.

FIG. 6 shows a variation of the ground anchor assembly 16 of FIG. 3A having a bottom end 37 that includes means for adjusting 78 the length of the ground anchor assembly 16. The bottom end 37 includes an opening 80 at its top portion. A modified anchor body 82 is positionable in the opening 80. Openings 84 in the sides of the body 82 are positioned at various places along the length of the body 82 to allow for adjustment of the overall length of the ground anchor assembly 16. In particular, a selected opening of the openings 84 may be aligned with the opening 80 of the bottom end 37 and a pin is inserted into the aligned openings to secure them together and fix the length of the ground anchor assembly 16. Cut-ins may be applied to the outer surface of the top portion of the bottom end 37 to allow for wrench placement and movement. Rotation of the bottom end 37 draws the bottom end 37 upwardly toward the top section 28. It is to be noted that additional intermediate anchor bodies of similar arrangement may be combined to increase the total length if necessary. Alternatively, selected components may be reduced in length as necessary in the field by cutting the top portion or the anchor body lengths down. It is to be noted in regard to the system of FIG. 6 that fitting 86 shown may be employed on one or more ground anchor assemblies 16 as shown. In particular, the fitting 86 may be an eyebolt, ring, or other looped structure installed at the top plate assembly 28. The fitting 86 may be screwed or bolted into the top plate 30 and the cable 34 passed therethrough. The fitting 86 may also be used to secure a guy wire about the trunk of the tree 100 if desired.

FIG. 7 shows an embodiment of the retention system 14 having an optional adjustment means 88 for adjusting the tension on the cable 34. In this embodiment, the cable 34 is retained in position to the two ground anchor assemblies 16 shown between the bottom plates 32 and the top plates 30. The adjustment means 88 is positioned on or around the cable 34 intermediate between the two ground anchor assemblies 16 and arranged to enable loosening or tightening of the cable as required by the condition of the ground, the assemblies, the tree or any combination thereof. It is to be noted that the cable 34 may be a single cable or it may include a plurality of cables, including, for example, an arrangement in which two cables are affixed to the adjustment means 88 at opposite ends thereof and either drawn toward, or pushed away from, one another.

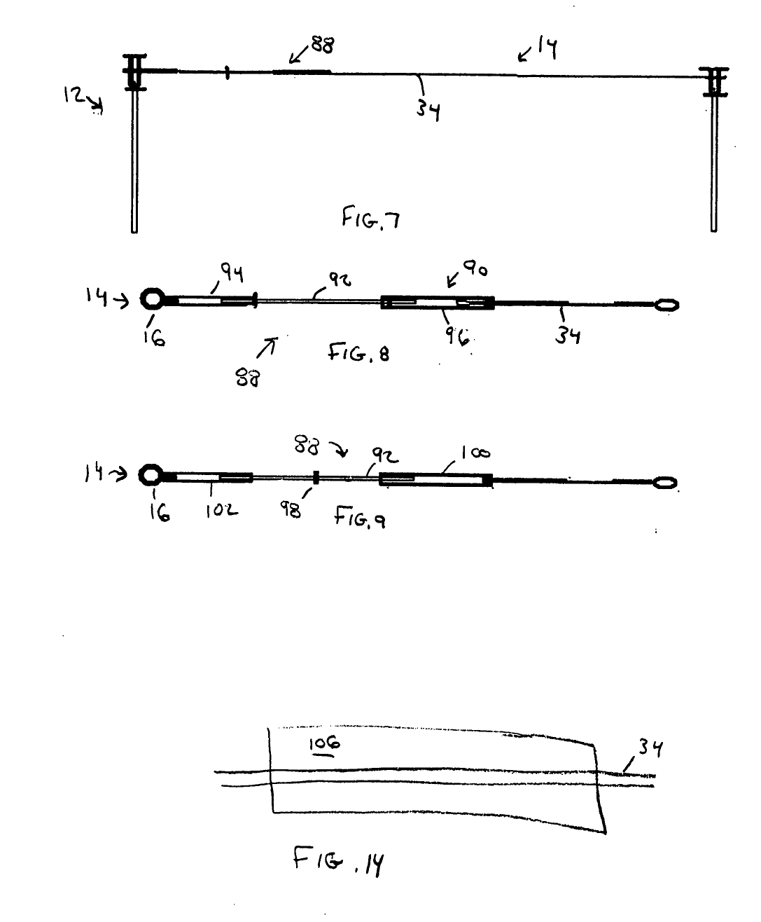

FIG. 8 shows a side view of a first embodiment of the adjustment means 88 with an adjustment assembly 90 that includes a threaded rod 92. One end of the threaded rod 92 is screwed into the hollow portion of a connecting structure 94 suitable for connecting to a ground anchor assembly 16. The second end of the threaded rod 92 is screwed into a rotatable adjusting structure 96. Rotating the rotatable adjusting structure 96 in one direction decreases the length of the retention system 14 (and thus the tension of the retention system) by drawing the threaded rod 92 further into the rotatable adjusting structure 96 opening. Rotating the rotatable adjusting structure 96 in the other direction has the opposite effect. The end of the rotatable adjusting structure 96 opposite from the end connected to the threaded rod 92 is connected to the cable 34, which, in turn, is suitable for connecting to a ground anchor assembly 16 as previously described.

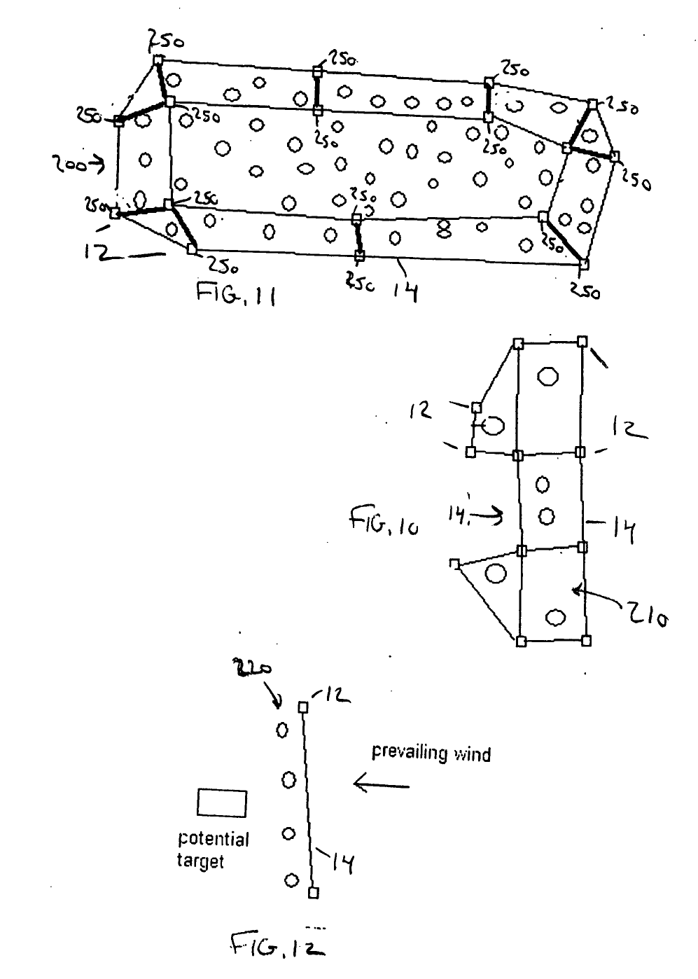

FIG. 9 shows a second embodiment of the adjustment means 88 that includes an adjustment nut 98. The adjustment nut 98 is connected to a threaded rod 92. One end of the threaded rod 92 is insertable into a coupling assembly 100 threaded at both ends thereof. The other end of the threaded rod 92 is connectable to a second coupling assembly 102 affixable to a ground anchor assembly 16. The other end of the coupling assembly 100 is affixed to the cable 34 in a non-adjusting manner. The cable 34 is, in turn, connectable to the ground anchor assembly 16. The second embodiment of FIG. 9 is distinct from the first embodiment of FIG. 8 in that the cabling of FIG. 8 is adjustable in both directions from by way of the threaded rod 92, whereas the second end of the coupling assembly 100 fixes the cable attached thereto without adjustment capability. Rotating the adjustment nut 98 changes the distance between the two coupling assemblies 100 and 102. Rotating the adjustment nut 98 in one direction decreases the distance between the two coupling assemblies 100 and 102 and thus increases the tension of the retention system. Rotating the adjustment nut 98 in the other direction has the opposite effect.

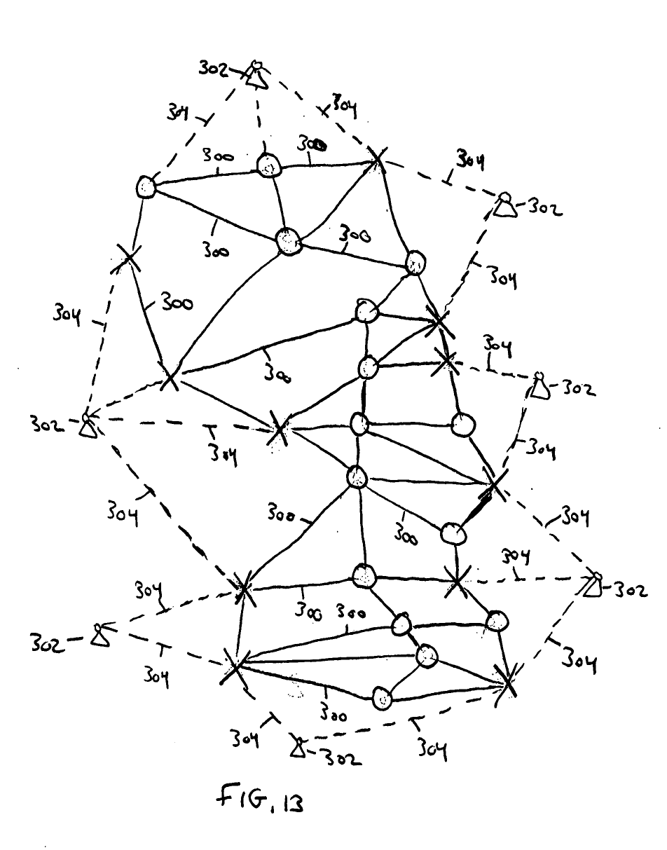

FIG. 10 shows the stabilization system of the present invention configured to stabilize a stand of trees 200. The perimeter anchor system 12 surrounds the stand of trees 200 and portions of the retention system 14 are run between several of the trees in the stand to increase the support. FIG. 11 shows yet another configuration to stabilize a large stand of trees 210. An outer portion of the perimeter anchor system 12 surrounds the outermost boundary of the stand 210. An inner portion of the anchor system 12 runs parallel to the outer portion, running along the inside edge of the outermost trees in the stand 210. At various points, portions of the retention system 14 are run between the outer and inner portions of the perimeter anchor system 12. Each portion of the perimeter anchor system 12 includes ground anchor assemblies 250. FIG. 12 shows yet another example of supporting a stand of trees 220. The stabilization system 10 is arranged in a line parallel to the line of trees to be stabilized. The stabilization system 10 is placed on the side of the stand 220 that encounters the prevailing wind.

In another embodiment of the stabilization system of the present invention for a stand of trees shown in FIG. 13, a series of triangulation combinations is established. A portion of the trees located generally about the perimeter of the stand are employed as anchor trees, designated in the drawing as trees “X,” while other trees of the stand to be stabilized are designated in the drawing as trees “O.” Above-surface retention lines 300 shown as solid lines are placed about and interconnect both types of trees. A perimeter anchor system including ground anchor assemblies 302 and anchor lines 304 located at or below the ground surface is established about the tree stand. However, as can be seen from the drawing, a portion of the anchor lines 304 extend into the tree stand to the root systems of certain ones of the anchor trees X. The retention lines 300, the ground anchor assemblies 302, and the anchor lines 304 are joined and arranged such that each tree of the stand is connected to at least two other trees of the stand or to at least one other tree and one or more ground anchor assemblies. This arrangement is distinct from the system of FIG. 11 in that the additional retention lines 300 are employed to create the triangular support arrangement without using anchor assemblies 302 about every tree of the stand. The ground anchor assemblies 302 and anchor lines 304 may be of any of the types previously described herein. The retention lines 300 and the anchor lines 304 may be of fabricated of the same material.

FIG. 14 shows an optional load distribution device 106 for distributing the downward pressure from the retention system 14 across a larger horizontal area than is provided by the cable 34 alone. The load distribution device 106 is preferably a strip, plate, or sheet wider than the cable 34 and is preferably fabricated of a material that can withstand the environment it will be in and also of sufficient strength to enable load distribution without causing root damage. The load distribution device 106 is therefore preferably a rubber or plastic pad or mat. The use of the device 106 ensures downward pressure from the retention system 14 is distributed across a wider horizontal area of the root system without causing root damage. Its position may be adjusted over time as required.

While the present invention has been described with particular reference to certain embodiments of the stabilization system, it is to be understood that it includes all reasonable equivalents thereof as defined by the following appended claims.

What is claimed is:

1. A tree anchoring apparatus comprising:
(a) a perimeter anchor assembly fixable in the underlying ground adjacent to the tree at or above the root system, said perimeter anchor assembly comprising a plurality of ground anchor assemblies, each ground anchor assembly including a top end and a bottom end; and
(b) a retention system including retaining means for retaining roots of a tree in position, the retaining means attachable to the top ends of the ground anchor assemblies.

2. The apparatus as claimed in claim 1 wherein each ground anchor assembly includes a top plate assembly, an anchor body, and a bottom end securable into the underlying ground.

3. The apparatus as claimed in claim 1 wherein the retaining means is an adjustable cable.

4. The apparatus as claimed in claim 1 wherein the bottom end of at least one of the ground anchor assemblies is configured to retain the ground anchor assembly in position in the underlying ground.

5. The apparatus as claimed in claim 1 wherein the ground anchor has a means for injecting a liquid phase capable of hardening into the surrounding soil.

6. A tree anchoring apparatus comprising:
(a) a perimeter anchor system fixable in the underlying ground, wherein the perimeter anchor system includes one or more ground anchor assemblies, each including a top end and a bottom end; and
(b) a retention system comprising one or more retaining means attachable to the anchor perimeter at the top end, said retention system including tension adjustment means.

7. The apparatus as claimed in claim 6 wherein the top end and bottom end of one or more of the ground anchor assemblies are detachable.

8. The apparatus as claimed in claim 6 wherein one or more of the ground anchor assemblies have a top plate.

9. The apparatus as claimed in claim 6 wherein the retaining means are one or more cables.

10. The apparatus as claimed in claim 6 wherein one or more of the ground anchor assemblies has a means for injecting a liquid phase capable of hardening into the surrounding soil.

11. An apparatus for anchoring a stand of trees comprising a perimeter anchor system adjacent to the trees to be anchored so that at least one side of the root system receives support, said perimeter anchor system having a plurality of ground anchor assemblies fixable into the underlying ground around the stand of trees, and a retention system comprising one or more retaining means attachable to the perimeter anchor system at the top end of each ground anchor assembly.

12. The apparatus as claimed in claim 11 wherein the top ends and bottom ends of the ground anchor assemblies are detachable.

13. The apparatus as claimed in claim 11 wherein the ground anchor assemblies have a top plate assembly.

14. The apparatus as claimed in claim 11 wherein the retention system includes one or more cables.

15. The apparatus as claimed in claim 11 wherein the ground anchor assemblies include a means for injecting a liquid phase capable of hardening into the surrounding soil.

16. An apparatus for anchoring trees comprising a perimeter anchor system adjacent to the trees to be anchored, the perimeter anchor system having a plurality of ground anchor assemblies fixable in the underlying ground, a retention system including one or more retaining means attachable to the perimeter at the top ends of each ground anchor assembly, and a means for increasing the horizontal area receiving the downward pressure asserted by the retention system.

17. The apparatus as claimed in claim 16 wherein the top end and bottom end of the ground anchor assemblies are detachable.

18. The apparatus as claimed in claim 16 wherein each of the ground anchor assemblies has a top plate.

19. The apparatus as claimed in claim 16 wherein the retaining means are one or more cables.

20. The apparatus as claimed in claim 16 wherein the ground anchor assemblies include a means for injecting a liquid phase capable of hardening into the surrounding soil.

21. The apparatus as claimed in claim 16 wherein the retention system includes tension adjustment means.

22. An apparatus for anchoring a stand of trees comprising a perimeter anchor system and retention lines, said perimeter anchor system having a plurality of ground anchor assemblies fixable into the underlying ground around the stand of trees and anchor lines extending from the ground anchor assemblies around a portion of the trees at the perimeter of the stand, and the retention lines extending among the trees of the stand such that each tree is connected to at least two other trees or at least one other tree and one or more ground anchor assemblies.

23. The apparatus as claimed in claim 22 wherein each of the ground anchor assemblies includes a top end and a bottom end, wherein the top ends and bottom ends of the ground anchor assemblies are detachable.

24. The apparatus as claimed in claim 22 wherein each of the ground anchor assemblies includes a top plate assembly.

25. The apparatus as claimed in claim 22 wherein the anchor lines are cables.
